(19) United States
(12) Patent Application Publication
(10) Pub. No.: US 2016/0169462 A1
(43) Pub. Date: Jun. 16, 2016

(54) TRACK SYSTEM FOR LIGHT EMITTING DIODE (LED) FIXTURE

(71) Applicants: James Bradford Hawkins, Liberty, MO (US); Jeremy Daniel Langton, St. Joseph, MO (US)

(72) Inventors: James Bradford Hawkins, Liberty, MO (US); Jeremy Daniel Langton, St. Joseph, MO (US)

(21) Appl. No.: 14/569,650

(22) Filed: Dec. 13, 2014

(51) Int. Cl. F21S 4/00; G01N 21/88; G01N 21/95

(52) U.S. Cl. CPC F21S 4/008; G01N 21/9515; G01N 21/8806; F21Y 2105/001

(57) ABSTRACT

A track system for light emitting diode (LED) fixture for providing multi-directional light to illuminate dents during paint less dent repair (PDR) in automobiles is disclosed. The track system includes a number of tracks running longitudinally along a back plate of the LED fixture, a number of protruding elements of the track system partitioning the adjacent tracks. Each track of the track system is configured for holding a LED strip. The track system is configured for use in the LED fixtures such that the LED strips embodied therein are replaceable.

### FIELD OF THE INVENTION

The present application generally relates to the field of light emitting diode (LED) fixtures. Particularly, the application provides a track system for holding the LED strips in a light emitting diode (LED) fixtures.

### BACKGROUND

Recent years have witnessed a tremendous growth in vehicular population across the globe, which has resulted in significant increase of vehicular accidents or damage caused by hail or other natural occurrences. The vehicular accidents may be categorized based upon the degree of damage. Unlike the heavily damaged vehicles, small dents can be repaired easily with the help of Paintless Dent Repair (PDR) tools and techniques. The Paintless dent repair (PDR) is a collection of standard techniques for removing minor dents from an automotive vehicle. With the advent of technology, variety of dent damages can be repaired using PDR. Amongst others, an efficient and effective light source is one of the essential tools while repairing and affirming the repaired dent of the automotive vehicle.

Conventional light emitting diode fixtures exist as efficient and effective light sources. However, the LED lights or strips in existing fixtures are either hard glued or require adhesive on their back to attach onto the LED fixture. Presently, any defects in the LED strips and user's desire for different color combination require either replacing the entire LED fixture or sending the LED fixture to an OEM for repair. In addition, existing manufactures need to make new and expensive molds for each model and size of the lighting fixtures, thereby adding cost of additional tooling or molding for each individual size of the fixtures, and significant engineering and designing costs.

Thus, in the light of the above mentioned background discussion, it is evident that, there is a need for some system or provision in the Light Emitting Diode (LED) fixtures that would help end users customize the LED fixtures, particularly enable changing the LED strips per their requirement at their end avoiding the need to send the fixtures to the manufacturers or OEM for repair or customization.

### SUMMARY

Before the present systems and methods, enablement are described, it is to be understood that this application is not limited to the particular systems, and methodologies described, as there can be multiple possible embodiments which are not expressly illustrated in the present disclosures. It is also to be understood that the terminology used in the description is for the purpose of describing the particular versions or embodiments only, and is not intended to limit the scope of the present application.

According to an illustrative embodiment of the invention, a track system for light emitting diode (LED) fixture providing multi-directional light to illuminate dents during paint less dent repair (PDR) in automobiles is disclosed. The track system includes a number of tracks running longitudinally along a back plate of the LED fixture. Each track is configured for holding a LED strip of the LED fixture. A number of protruding elements partition the adjacent tracks. The track system is configured such that the LED strips are replaceable.

### BRIEF DESCRIPTION OF THE DRAWINGS

The foregoing summary, as well as the following detailed description of preferred embodiments, is better understood when read in conjunction with the appended drawings. There is shown in the drawings example embodiments, however, the application is not limited to the specific system and method disclosed in the drawings.

FIG. 1 shows front view of an example curved light emitting diode (LED) fixture without front white translucent lens, according to an exemplary embodiment;

FIG. 2a shows a perspective view of an example curved light emitting diode (LED) fixture embodying the proposed track system, according to an illustrative embodiment of the invention;

FIG. 2b shows a side view of the proposed track system designed for light emitting diode (LED) fixture, according to the illustrative embodiment of the invention;

FIG. 3 shows a perspective view of an example curved light emitting diode (LED) fixture embodying the proposed track system, according to another illustrative embodiment of the invention; and

FIG. 4 shows an exploded view of an example curved light emitting diode (LED) fixture embodying track systems of the proposed invention, according to another illustrative embodiment of the invention.

### DETAILED DESCRIPTION

Some embodiments, illustrating its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any methods, and systems similar or equivalent to those described herein can be used in the practice or testing of embodiments, the preferred methods, and systems are now described. The disclosed embodiments are merely exemplary.

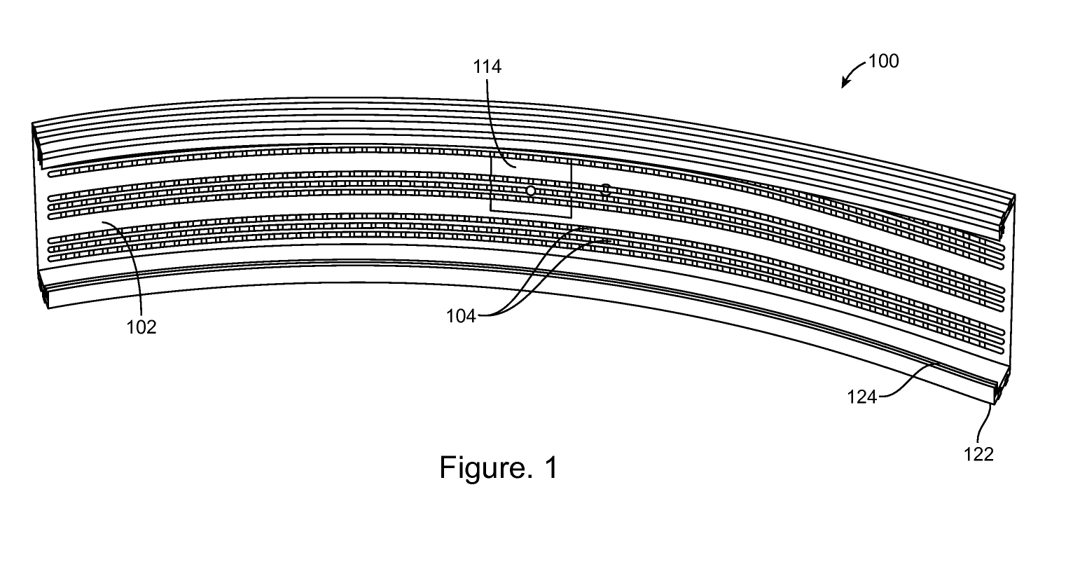

Referring to FIG. 1 is an example curved light emitting diode (LED) fixture without front white translucent lens, according to an exemplary embodiment.

Generally, the light emitting diode (LED) fixture (100) for paint less dent repair (PDR) in automobiles is characterized in providing multi directional light to illuminate dents on automotive vehicles while repairing such dents. The LED fixture (100) as shown includes a back plate (102). As seen, the back plate (102) may be defined as a component that may be provided for housing LED strips (104). The back plate (102) as seen in the FIG. 1 is curved, but it may be linear in case of linear lighting fixtures. With reference to the example curved LED fixture (100) shown in FIG. 1, the back plate (102) has an extension (122) lying perpendicular to the back plate (102) and attached on the horizontal side of the back plate (102). The extension (122) may have its edges hanging perpendicularly to the extension (122). The back plate (102) is made from materials which include, but are not limited to polycarbonate, polypropylene and/or combination thereof, and so on. The example curved light emitting diode (LED) fixture (100) shows the back plate (102), the top and bottom extension (122) as a single piece unit. In some other embodiments, the top and the bottom extensions (122) and the back plate (102) may separate components capable of being removably attached.

As seen, a number of LED strips (104) are affixed along an upper and a lower edge of the back plate (102), running along the length of the back plate (102). The LED strips (104) are employed for providing multi directional light to illuminate dents on automotive vehicles. The LED strips (104) may be evenly spaced and have length equal to the length of the LED fixture (100). The LED strip (104) shown in the example curved LED fixture has length of approximately 120 cm and width of 8 mm or 10 mm and are hard glued onto the back plate (102). The LED strips (104) have colors which include but are not limited to white, yellow, blue, green and/or combinations thereof, and so on.

As seen, a raceway (124) is affixed to an inner surface of the extension (122) of the back plate (102) for accommodating a white translucent lens (not shown). The white translucent lens covers LED strips (104) disposed onto the back plate 102.

Further, a pair of plates (114) is seen affixed in the middle of the back plate (102), one each at the front and the back side of the back plate (102). A brass pivotal ball (not shown) may be screwed in the metal plate (114) on the back side of the back plate (102), providing a passageway for passing through a power cord. The plates (114) are made from any metal that is well known in the art. Examples of the metal may include, but are not limited to a power coated aluminum and steel. The fixture (100) may have set of control switches for controlling action of the LED strips (104) affixed onto the back plate (102). In some embodiment, the control switches may be disposed on the rear side of the back plate (102) and be made of plastic or ABS.

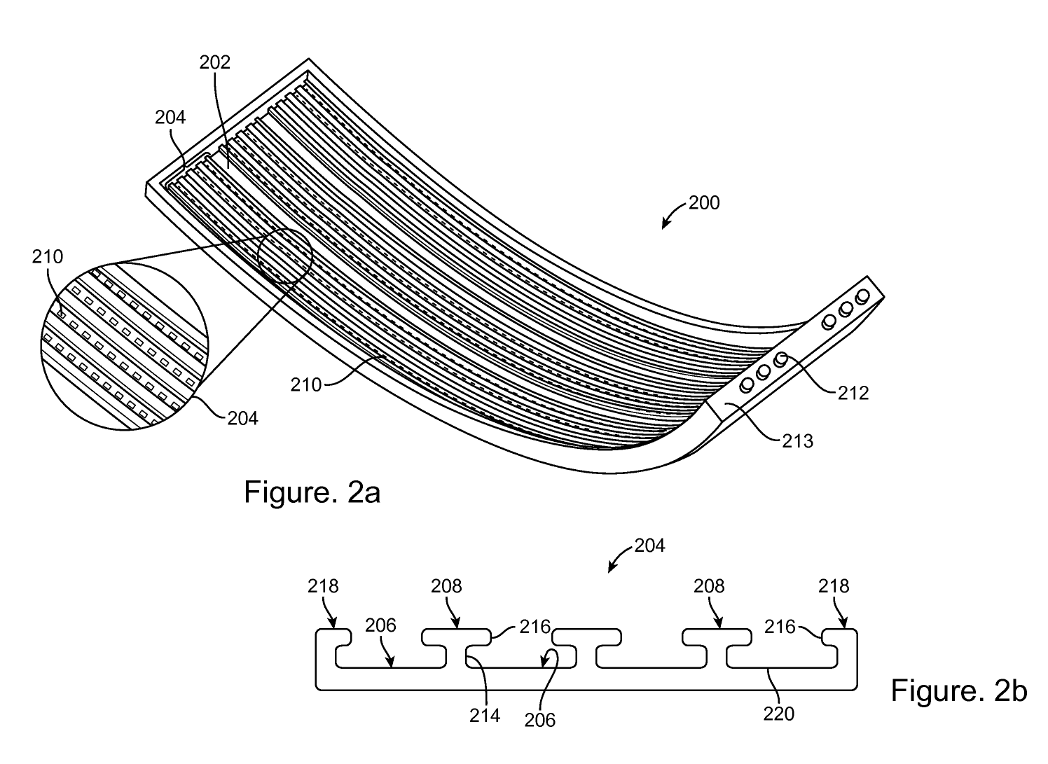

In some embodiment, the control switches may be in the form of push buttons (212) disposed on the side plate (213) as shown in FIG. 2a, According to some embodiment, the push buttons (212) may be made of 16 mm stainless steel or nickel plated brass to add reliability and durability to the LED fixture (100). The push buttons (212) may be employed to switch on and off, thereby causing the LED strips (210) to switch on and off respectively. One push button (212) may control operation of one or more LED strip (210).

In the LED fixture (100) design briefly described above, whenever any defect occurs in any LEDs or the end user requires different LED light combination, the end user needs to either discard the LED fixture and buy a new fixture or send the existing LED fixture to an OEM for repair and/or customization.

FIG. 2a illustrates a perspective view of the example curved light emitting diode (LED) fixture embodying the proposed track system (204) disposed on a concave/inner surface of a back plate (202) of the LED fixture. The LED fixture (200) may have structure and function similar to the example curved LED fixture described above with reference to FIG. 1 except the track system (204), details of which are disclosed herein. The track system (204) may be defined by a number of tracks (206) running along the length of the LED fixture (200), as clearly shown in a zoomed out view and in FIG. 2b. A number of track systems (204) may be configured for holding LED strips (210) in the LED fixture (200). In some embodiments, the track system (204) may be detachably attached or permanently affixed via glue or silicon adhesive or by any other known method on the concave/inner surface of the back plate (202). In some embodiments of the invention, the track system (204) may be in the form of an extruded framework that may be manufactured and then disposed on the concave/inner surface of the back plate (202).

As shown in FIG. 2b depicting the side view of the track system (204), the track system (204) may include a number of protruding elements (208), providing as a partition between the two tracks (206). The protruding elements (208) may be defined as T-shaped projections having hanging edges, providing as a support for retaining the LED strips (210) within the tracks (206). The protruding elements (208) may be configured to run along the length of the tracks (206) and hence the length of the LED fixture (200). Thus, two protruding elements (208) define one track (206) for holding one LED strip (210). As in illustration, four protruding elements (208) may define three tracks (206), retaining three LED strips in the corresponding tracks (206).

As seen in FIG. 2b, the track system (200) may have dimensions as per the user's requirements. For example, the T-shaped protruding element (208) may be 5.5 mm long and have its base (216) of 7 mm width, lying perpendicular to its leg (214) of 2 mm width. There may be L-shaped protruding elements (218) disposed on extreme either sides of the track system (204). Length of the protruding elements (218) may be same as that of the protruding elements (208). The protruding element (218) may have its base width as 3.5 mm and leg width as 2 mm. The track (206) may have its width specific to width of the LED strip (210). The tracks (206) may include a covering (220), providing as a base to hold the LED strip (210). The covering (220) may be made from same material as that of the protruding elements (208), (218), and may have same thickness as that of the legs of the protruding elements (208), (218). Length of the covering (220) may be same or greater than the width of the LED strip (210). For any persons skilled in the art, it may be contemplated that the dimensions disclosed above in number are mere examples and disclosed for the sake of explanation of the invention.

Further, the track system (204) may be employed for holding the LED strips (210) such that the LED strips (210) may slide within the tracks (206). Hence, if any LED strip (210) may get defective or fused, a user may pull out the defective or fused LED strip (210) from the track (206) and reinstall a new LED strip (210), thereby avoiding replacement of the entire LED fixture (200).

According to the illustrative embodiment, it is shown each track system (204) can hold four LED strips (210). Further, in the illustrative embodiment, three track systems (204) are shown configured on the back plate (202) of the LED fixture (200), thereby allowing the user to accommodate up to 12 LED strips (210). But it should be understood that number of tracks (206) in each track system (204) can be increased or decreased based on the requirement. The various criteria on which the increase and decrease in the number of tracks (206) and track system (204) for any LED fixture may depend on tooling cost towards manufacturing of the track systems (204) and varying sizes of LED light fixture (200).

In an embodiment of the invention, LED strips (210) of different colors may slide within the tracks (206) of the track system (204). Thus, a user may have provision to use LED strips (210) of different color combinations of their choice. For example, the user may use up to 12 LED strips (210) in the LED fixture (200) using three track systems (204), and each LED strips (210) may be of different color of user's choice. Based on the requirement, the user may have option to use varied number of LED strips (210) at various preferred locations. For example, some users desire to have more light illumination near the middle, or top or bottom of the fixture (200). For user those who have light preference at the middle of the fixture (200) may avoid placement of LED strips (210) at the top and bottom tracks (206) of the track systems (204) lying at the upper and a lower edge of the back plate (202).

In some other embodiments of the invention, a user may have provision for using LED strips (210) of different light intensities, for example, one LED strip (210) may be of DC 12V and other LED strip (210) may be of DC 14V. Sometimes, the user may require repairing a dent in immense dark, thus the LED strips (210) of greater light intensity may slide within the tracks (206).

According to some embodiment, the track systems(204) as illustrated in the FIG. 2a, may be designed to accommodate the LED strips (210) of different widths as commonly available width of the LED strips (210) vary from 8 mm to 10 mm, so it should be apparent to those skilled in the art that the proposed track systems (204) can be suitably designed to support varying width of LED strips (210) such that, a user may slide LED strips (210) of different width in same lighting fixture (200). For instance, within the track system (204) having four tracks (206), two tracks (206) may be supporting the LED strips (210) of 8 mm wide, and two tracks (206) may be supporting the LED strips (210) of 10 mm wide, and any combinations thereof. Thus, width of the tracks (206) may be made specific to any dimensions of the LED strip (210) as needed.

In some embodiments, the track system (204) may be made from materials that are well known in the art. Examples of materials may include but are not limited to plastic, ABS and so on.

Looping back to FIG. 2a, to facilitate the customization of the LED fixture (200) by allowing replacement of the LED strips (210), the LED strips(210) may be provided with male connects that removably engages with the female connects linked to the push buttons (212) present on the side plate (213). According to the embodiment, a disconnect male and female connectors are soldered to an end of the LED strips(210) and the push buttons(212) for allowing engagement of the LED strips (210) with the push buttons(212). During the replacement operation of the LED strips (210), the user is simply required to open the push button (212) end cap, pull out the front lens (not shown) of the LED fixture (200), change the LED strip (210), and then re-install the front lens and screw the end cap back on the push button(212).

The push buttons (212) are defined as buttons which may be employed to switch on and off, thereby causing the LED strips (210) to switch on and off respectively. One push button (212) may control operation of one or more LED strip (210). In the illustrative embodiment shown, the push buttons (212) are shown in one of the side plates (213), but it should be apparent to those skilled in the art that the push buttons (212) may be present on both the side plates (213). Though six push buttons are shown configured in the illustrative embodiment to control six LED strips (210), it is assuming the user at a time may be using at most six LED strips (210), but it should be apparently understood that suitable connectors might be employed to extend the use of the push buttons (212) for increased numbers of LED strips(210) without increasing number of push buttons (212) in the LED fixtures (200).

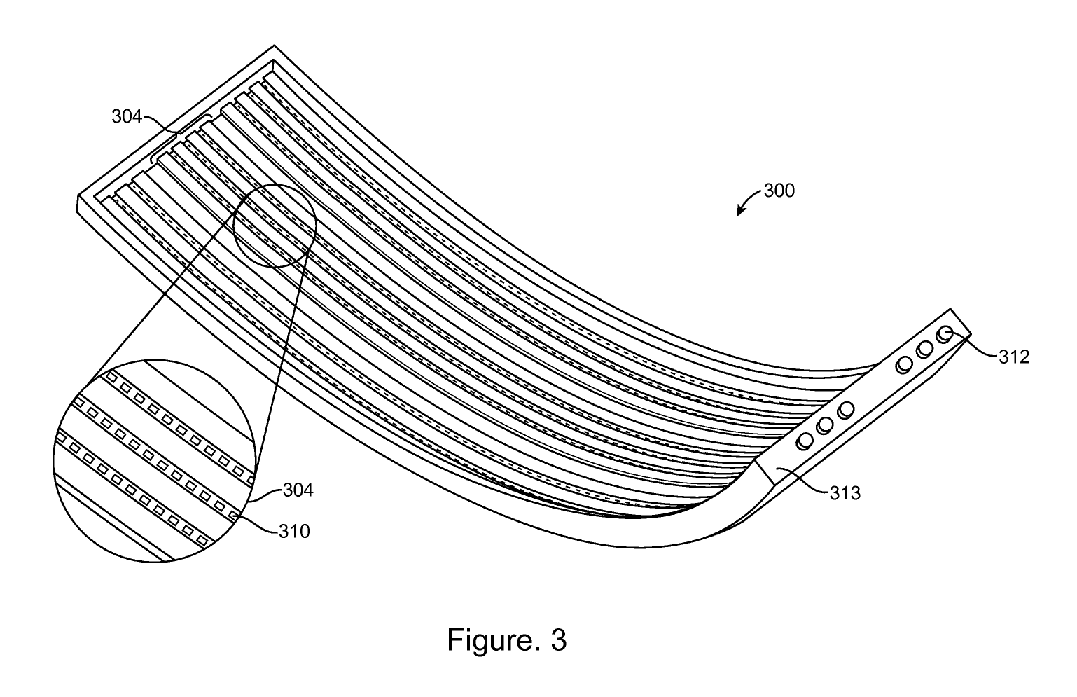

As shown in FIG. 3, a track system (304) may be disposed on the concave/inner surface of a LED fixture (300). The LED fixture (300) may have structure and function similar to the example curved LED fixture described with reference to FIG. 1, except the track system (304), details of which are disclosed herein. According to some embodiments of the invention, the track system (304) may be embedded on the concave/inner surface of the LED fixture (300). The track system (304) may be embedded on the concave/inner surface of the LED fixture (300) while the LED fixture (300) is manufactured. In some embodiments, the track system (304) may be carved or milled in the concave/inner surface of the LED fixture (300). Structurally and functionally the uses of the track system (304) remains same as the track system (204) described with reference to the FIG. 2a, and FIG. 2b.

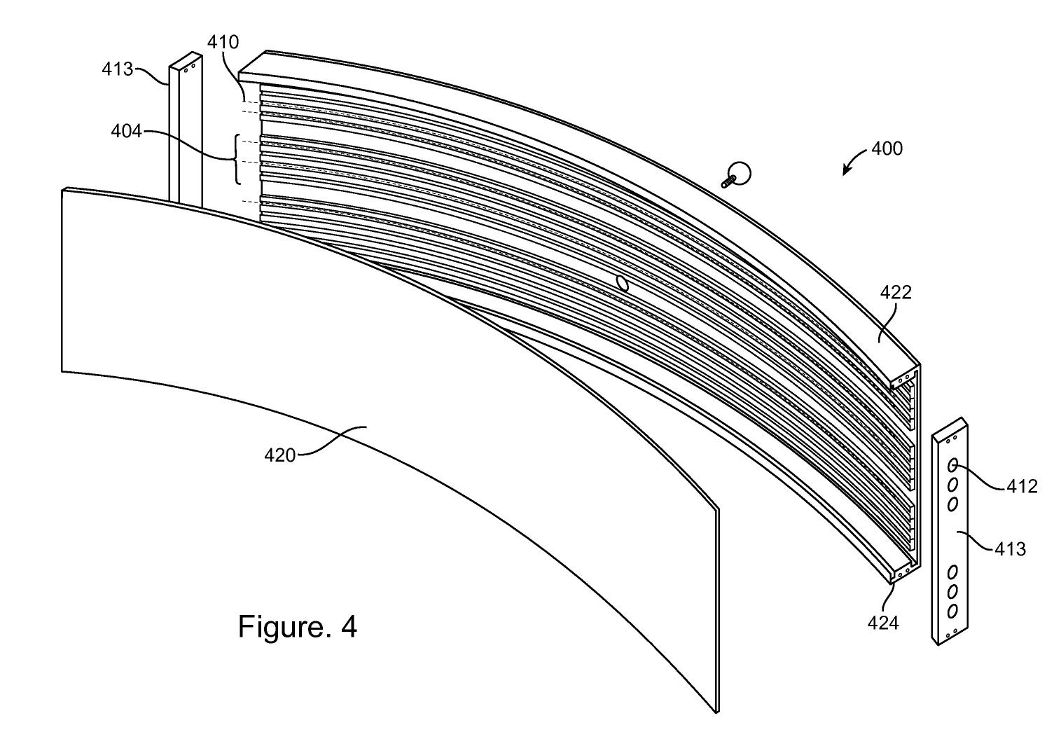

FIG. 4 shows an exploded view of an example curved light emitting diode (LED) fixture embodying track systems of the proposed invention. Various components of the LED fixture (400), namely side plate (413), push buttons (412), track system (404), LED strips (410), lens (420), extension (422), raceway (424) have structure and function similar to the components described above. The LED fixture (400) is seen embodying the proposed track system (404) that enables customization of the fixture (400) by the end user wherein the end user can easily replace the LED strips (410) without having to take the fixture (400) to the manufacturer for repair. As explained above with reference to the FIG. 2a, and FIG. 2b, user can easily replace the desired LED strips (410) in the fixture (400) with new LED strips (410). As seen, the replacement operation of the LED strips (410) would run as: opening of the push button (412) end cap by the end user, pulling out the front lens (420) of the LED fixture (400), replacing the defective or undesired LED strip (410) with the new LED strips (410), and then re-installing the front lens (420) and screwing the end cap back on the push button (412).

The invention as described above is with reference to curved LED fixture, it should be apparently understood the invention is not limited in its scope to its use with the curved LED fixture, rather the invention can be reduced into practice with any other lighting fixtures commonly available in the industry, may it be linear or curved.

The illustrations of arrangements described herein are intended to provide a general understanding of the structure of various embodiments, and they are not intended to serve as a complete description of all the elements and features of apparatus and systems that might make use of the structures described herein. Many other arrangements will be apparent to those of skill in the art upon reviewing the above description. Other arrangements may be utilized and derived there from, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

The preceding description has been presented with reference to various embodiments. Persons skilled in the art and technology to which this application pertains will appreciate that alterations and changes in the described structures and methods of operation can be practiced without meaningfully departing from the principle, spirit and scope.

We claim:

1) A track system for light emitting diode (LED) fixture providing multi-directional light to illuminate dents during paint less dent repair (PDR) in automobiles, the track system comprising:
a number of tracks running longitudinally along a back plate of the LED fixture, wherein each track is configured for holding a LED strip of the LED fixture; and
a number of protruding elements partitioning the adjacent tracks;
wherein the track system is configured such that the LED strips are replaceable.

2) The track system of claim 1, wherein the LED fixture is curved.

3) The track system of claim 1, wherein the LED fixture is linear.

4) The track system of claim 1, wherein the track system is disposed on the back plate of the LED fixture.

5) The tack system of claim 1, wherein the track system is embedded within the back plate of the LED fixture.

6) The track system of claim 1, wherein the track system can hold any number of LED strips of the fixture.

7) The track system of claim 1, wherein the LED strips can slide within the tracks.

8) The track system of claim 1, wherein the tracks can hold LED strips of any dimension.

9) The track system of claim 1, wherein the tracks can hold LED strips of 8 mm wide.

10) The track system of claim 1, wherein the tracks can hold LED strips of 10 mm wide.

11) The track system of claim 1, wherein the LED strips of different dimensions can be held within one LED fixture.

12) The track system of claim 1, wherein the LED strips of different colors can be held within one LED fixture.

13) The track system of claim 1, wherein the LED strips of different light intensities can be held within one LED fixture.

14) The track system of claim 1, wherein at least one track system can be disposed on the back plate of the LED fixture.

15) The track system of claim 4, wherein the track system is detachable.

16) The track system of claim 4, wherein the track system is affixed on the back plate of the LED fixture.

17) The track system of claim 16, wherein the track system may be affixed using glue and silicon adhesive.
